(19) United States
(12) Patent Application Publication
(10) Pub. No.: US 2024/0014918 A1
(43) Pub. Date: Jan. 11, 2024

(54) REMOTE CHARACTERIZATION OF OPTICAL COMPONENTS IN MULTI-SPAN OPTICAL FIBER LINKS

(71) Applicant: Danmarks Tekniske Universitet, Kongens Lyngby (DK)

(72) Inventors: Metodi Plamenov Yankov, Kongens Lyngby (DK); Rasmus Thomas Jones, Kongens Lyngby (DK)

(21) Appl. No.: 18/217,758

(22) Filed: Jul. 3, 2023

(30) Foreign Application Priority Data
Jul. 6, 2022 (EP) 22183336.1

(51) Int. Cl. H04J 14/02

(52) U.S. Cl. CPC H04J 14/0227; H04J 2203/0076

(57) ABSTRACT

The present disclosure relates to a remote characterization of optical components in multi-span fiber links, the characterization based on a parametric model of optical components, such as a machine learning model. The present disclosure also relates to the use of the presently disclosed model for optimization of a link, based on an arbitrary optimization strategy related to the spectral power profile and the quality of service of the link.

### CROSS-REFERENCE TO RELATED APPLICATIONS

The present application claims the benefit of European Patent Application No. 22183336.1, entitled “Remote characterization of optical components in multi-span optical fiber links” and filed on Jul. 6, 2022, which is hereby incorporated by reference herein in its entirety.

### TECHNICAL FIELD

The present disclosure relates to a remote characterization of optical components in multi-span fiber links, wherein the characterization is based on a parametric model of the optical components, such as a machine learning model. The present disclosure also relates to the use of the presently disclosed model for optimization of a link, based on an arbitrary optimization strategy related to the spectral power profile and the quality of service of the link.

### BACKGROUND

Wide-band wavelength division multiplexing (WDM) optical communication systems and all optical amplification are cornerstones of our modern digital information infrastructure and are responsible for today's high transmission data rates.

A typical WDM network comprises a plurality of fiber channels and optical components such as optical amplifiers, typically Erbium-Doped Fiber Amplifiers (EDFAs), switches, filters and other components.

The nonlinear wavelength dependence of the gain and noise on each channel in a WDM system is a key detrimental effect governing the quality of transmission per user in WDM networks. In wide-band WDM systems, wavelength dependent effects such as transceiver penalties, nonlinear fiber effects, and non-flat EDFA gain and noise contributions are non-trivial to model.

### SUMMARY

The present disclosure addresses the problem of modelling non-linear optical components, such as EDFAs, and using the obtained models to optimize a fiber link based on an optimization strategy.

The present disclosure relates to a method for obtaining a parametric model of a first optical component of a probed link in a WDM optical network comprising a plurality of link sections, the probed link comprising one or more of said link sections, each link section comprising a length of optical fiber and at least one of said first optical components, such as an optical amplifier. In the preferred embodiment the probed link has been probed by a predefined WDM input signal and a measured WDM output signal. The method may comprise the step of providing a link transfer model based on the predefined WDM input signal and the measured WDM output signal, i.e. a link transfer model can be provided based on the measured input and output data. The first optical component can then be isolated from the link transfer model, for example by using analytical models for the optical fiber and preferably removing the impact of the optical fiber from the link transfer model to obtain an optical component model. Based on the optical component model and the predefined WDM input signal parameters can be determined by means of iterative comparison between calculated WDM output signal and the measured WDM output signal.

The inventors have realized that a component of interest, such as a first EDFA, may be isolated not only by removing the impact of the optical fiber from the transfer function, but also by removing the impact of any other known component. I.e. the probed link may comprise at least one second optical component, e.g. different from the first optical component, wherein the first optical components is isolated from the link transfer model by also removing the impact of said at least one second optical component.

For example, a link composed of fiber, amplifier A, fiber, may be used to learn the parameters of amplifier A. Then a link composed by fiber, amplifier A, fiber, amplifier B, fiber, may be used to learn the parameters of amplifier B by removing the effect of the fibers and amplifier A from the total transfer function. This allows to sequentially obtain models for different components.

In the presently disclosed method of characterization and/or modelling, it is assumed that a given fiber link or fiber link section comprises at least one fiber channel and at least one optical component, such as an EDFA, or a switch, or a filter. Hence, the preferred embodiment is based on having and/or obtaining data of only a part of a deployed WDM optical network, maybe only a small part of the network, and use this data to build a realistic model of the entire WDM network.

Fiber channel effects are reasonably well captured by analytical models. However, accurate representation of EDFAs using analytical models is challenging. Machine learning (ML) and data aided EDFA models are alternatives that gather attention from the community. However training an ML model for an EDFA and other link components requires full access to its input and output in a lab environment. Yet, deployed fiber links and their respective components cannot be physically isolated and used for data driven modelling approaches. Further, aging effects of an EDFA device are difficult to measure and model after the device has been deployed.

The presently disclosed method of characterization and/or modelling of optical components may be used for collecting remote measurement data from the link directly, without having to isolate the optical components in a lab, which is typically impractical and would require to put the link out of function in order to take account of effects due to deployment, such as ageing. The presently disclosed method of characterization and/or modelling of optical components may therefore be able to fully model an optical component remotely, while the optical component is deployed in a network or fiber link by using measurements directly taken from the network, or from a fiber link, and may therefore be able to capture any effect due to deployment.

As channel effects are well modelled by analytical models, but optical components are not well modelled by analytical models, the inventors have realized that a link section comprising at least one fiber channel and at least one optical component may be well modelled by a hybrid model, such as a twin model, comprising an analytical model for the fiber channel and a parametric model for the optical component, wherein the parametric model may be trained based on data from remote measurement from the link. The use of the analytical model of the fiber channel removes the effect of the fiber from the optical component model and isolates the optical component model. This way, during training or during iterative optimization of parameters of the optical component model, effects related to the optical component are taken into account and isolated from effects of the fiber channel. The analytical model for the channel may comprise several analytical models for the channel subsections.

In one embodiment of the present disclosure, the parametric model for the optical component may be a machine learning model.

In one embodiment of the present disclosure data concerning input and output of a link section are collected and used to determine the parameters of the optical component model, or to train the optical component model. Inputs may be input signals to the fiber link or section link and outputs are output signals from the fiber link or the section link. Therefore all data needed to train and/or to determine parameters of the optical component parametric model can be collected at the ends of the fiber link or fiber section, that is at an input end and at an output end, without having to isolate in a laboratory the optical component. Input end and output end of the network, or fiber link, may be remotely located from each other, at distances of tens or hundreds or thousands of kilometers.

The present disclosure is further related to a method for optimizing the quality of service of a remote link in a WDM optical network, the remote link comprising a plurality of link sections, each link section defined by a length of optical fiber and at least one optical component, such as an optical amplifier, the method comprising the steps of:
modelling the WDM optical network link based on the link configuration to obtain a digital twin model of the WDM optical network link, wherein the digital twin model comprises an analytical model for the optical fibers and a parametric model for at least one of the optical components;
calculating or predicting an output optical signal to noise ratio of an input WDM signal based on the digital twin model; and
optimizing the quality of service of the WDM optical network link by determining an input WDM signal that optimizes the corresponding output optical signal to noise ratio,
wherein parameters of the parametric model(s) for the at least one optical component are determined based on measurements on a probed link of the WDM optical network, and wherein the probed link may be different from the remote link.

Once a model of an optical component is obtained using the presently disclosed method for characterization and/or modelling of an optical component, the optical component parametric model, so obtained with data from a probed link, may be used to model and optimize a remote link that may comprise a plurality of link sections with a plurality of optical components. The remote link may comprise a plurality of fiber channel sections, modelled using an analytical model, and a plurality of optical components, modelled using the parametric optical component models.

The remote link may comprise a plurality of users, for example with each user associated to a different wavelength. Given a total input power, which may be determined, for example, by a given transmitter, the model of the remote link, comprising the models for the optical components and the models for the fiber channels, may be used to predict the output spectral signal. More specifically, a given spectral input signal, that is a given distribution of the input power over all users and/or over all wavelengths, may generate a specific output spectral power and a specific distribution over the users and/or the wavelengths of the signal to noise ratio.

Further, the model of the remote network, so built using models of the optical components, may be used to optimize the input spectral power distribution among users and/or wavelengths in order to obtain a target distribution of the output signal to noise ratios over users/and or wavelengths. In particular, a flat distribution of the output signal to noise ratio may be achieved over the wavelengths or users, or an output distribution of the signal to noise ratio which favors users who are paying for a more expensive connection or any other arbitrary and/or pre-defined distribution that the data provider may find useful. The distribution of the output signal to noise ratio per user and/or wavelength may be optimized for any worst-case scenario based on an arbitrary and/or predefined optimization strategy. The distribution of the output signal to noise ratio may be optimized dynamically based on different optimization strategies at different times.

Each of the presently disclosed methods may be implemented on a computer. The presently disclosed therefore further relates to a system, for example comprising a processing unit, configured for executing each of the methods disclosed herein. The present disclosure further relates to a computer program having instructions which, when executed by a computing device or computing system, cause the computing device or computing system to carry out any of the methods disclosed herein.

### DESCRIPTION OF THE DRAWINGS

The present disclosure will in the following be described in further detail with reference to the accompanying drawings:

FIG. 1 shows a flow diagram of one embodiment of the presently disclosed method for modelling at least one optical component;

FIG. 2 shows a flow diagram of one embodiment of the presently disclosed method for optimization;

FIG. 3 shows a schematic diagram of an embodiment of a training process for the machine learning model used in one embodiment of the presently disclosed method for modelling at least one optical component;

FIG. 4 shows an embodiment of a transceiver setup for a communication link comprising a transmitter Tx, a Receiver Rx and a fiber network;

FIG. 5 shows calculated and measured SNR margin to the SNR decoding threshold and measured and predicted OSNR for two exemplary links, with flat input power distribution; and.

FIG. 6 shows optimized SNR margin profiles for two exemplary links using embodiments of the presently disclosed optimization method.

### DETAILED DESCRIPTION

### Definitions

As used in this description and the accompanying claims, the following terms shall have the meanings indicated, unless the context otherwise requires:

A “set” includes at least one member.

### Method for Modelling an Optical Component

In one embodiment of the present disclosure the optical component is an Erbium-Doped Fiber Amplifier (EDFA).

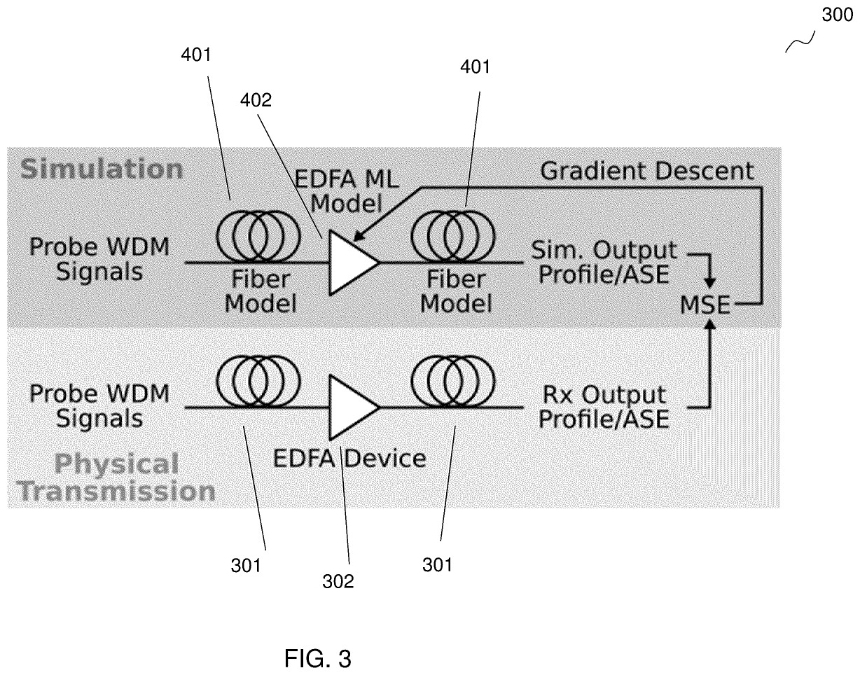

EDFA are optical components that suffer from non-linearity and are difficult to be characterized by analytical models based, for example, on laboratory data. EDFAs suffer, for example, from aging and their behavior may be very difficult to predict once the EDFAs are installed or deployed in a link. Modelling EDFAs remotely while they are installed or deployed in a link is advantageous for being able to obtain a model that reflects aging effects or any other effect due to deployment, which cannot be modeled in the laboratory. The presently disclosed method, applied to a link comprising a fiber channel and an EDFA, permits remote characterization and/or modelling of the EDFA, based on knowledge of input signals at a remote input end of the fiber and based on measurements at the remote output end of the link and based on training or optimization of a parametric model of the optical component, in combined with an analytical model of the fiber channel. The combined model of the fiber channel and the EDFA is a twin model or hybrid model, as it comprises an analytical model for the fiber channel and a parametric or machine learning model for the EDFA. This is shown in FIG. 3 where the parametric model for the optical component 402 is combined with the analytical model 401 for the fiber channel. The analytical model 401 may, for example, be a Gaussian Noise model including attenuation and stimulated Raman scattering (SRS) effects. A detailed description of an exemplary analytical model can be found in M. P. Yankov, P. M. Kaminski, H. E. Hansen, and F. Da Ros, “SNR optimization of multi-span fiber optic communication systems employing EDFAs with non-flat gain and noise figure,” J. Light. Technol. 39, 6824-6832 (2021), which is incorporated herein by reference in its entirety.

In one embodiment of the present disclosure, the optical component is a switch or a filter. Other optical components that suffer from deployment dependent effects are switches or filters.

In the present disclosure, the model of the optical component may be parametric, i.e. it may contain parameters. Parameters of the model are obtained by iterative comparison between experimental results and model predictions. In one embodiment of the present disclosure the model of the optical component may be a machine learning model with parameters, such as weights and biases of a neural network. Parameters of the machine learning model may be obtained by training based on measurements and comparison with predictions of the machine learning model. In particular, the training data set of the machine learning model may comprise transmitted input signal values of a fiber link and measured output signal values of the fiber link.

In one embodiment of the present disclosure, the parameters of the optical component model are determined by training the optical component model by means of machine learning based on the predefined WDM input signal and the measured WDM output signal. Measurement data of the output signals are recorded for a given time, together with input signals and this data is used for training of the machine learning model.

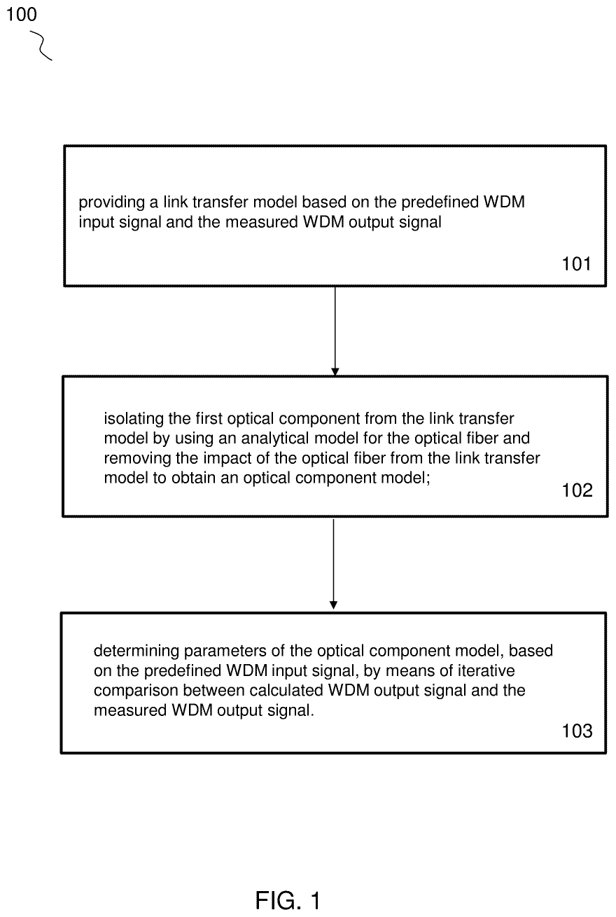

FIG. 1 discloses one embodiment 100 of the present disclosed approach of obtaining a parametric model of a first optical component of a set of optical components of a probed link in a WDM optical network comprising a plurality of link sections, the probed link comprising one or more of said link sections, each link section comprising a length of optical fiber and at least one of said set of optical components the probed link probed by a predefined WDM input signal and a measured WDM output signal. In 101 a link transfer model is initially provided based on the predefined WDM input signal and the measured WDM output signal. Then in 102 the first optical component is isolated from the link transfer model by using an analytical model for the optical fiber and removing the impact of the optical fiber from the link transfer model to obtain an optical component model. And finally in 103 parameters of the optical component model are determined, based on the predefined WDM input signal, by means of iterative comparison between calculated WDM output signal and the measured WDM output signal.

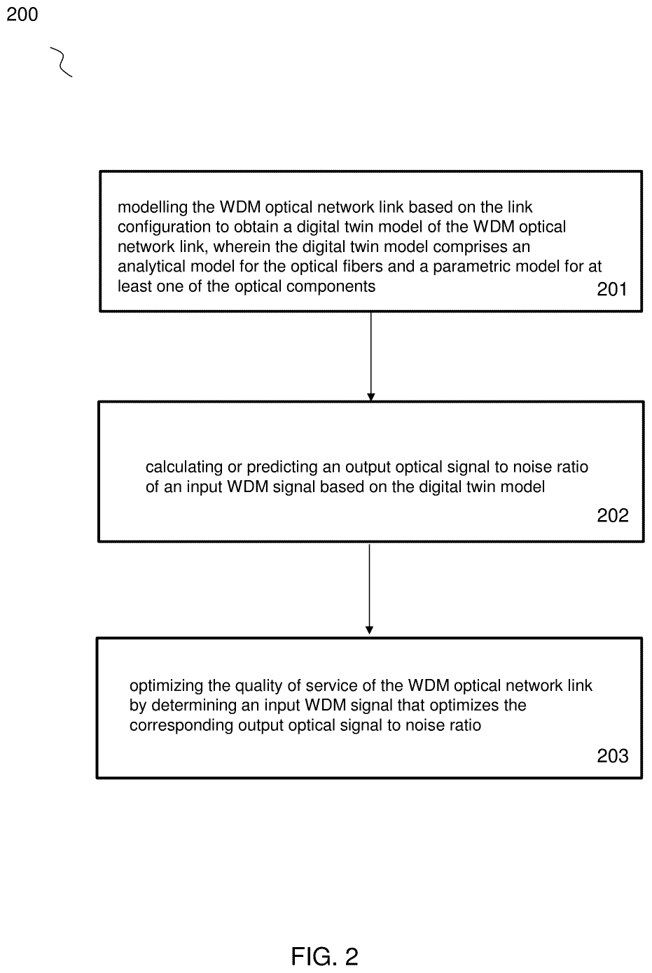

FIG. 2 discloses another embodiment 200 of the present disclosed approach of optimizing a quality of service of a remote link in a WDM optical network, the remote link comprising a plurality of link sections, each link section comprising a length of optical fiber and at least one optical component. Initially in 201 the WDM optical network link is modelled based on the link configuration to obtain a digital twin model of the WDM optical network link, wherein the digital twin model comprises an analytical model for the optical fibers and a parametric model for at least one of the optical components. In 202 an output optical signal to noise ratio of an input WDM signal based on the digital twin model is calculated and/or predicted. And then in 203 the quality of service of the WDM optical network link is optimized by determining an input WDM signal that optimizes the corresponding output optical signal to noise ratio.

FIG. 3 shows an embodiment of the training process 300 of one embodiment of the presently disclosed method. In this embodiment the link is modelled by an analytical model 401 modelling the fiber channel and by a machine learning model 402 modelling the optical component, such as an EDFA. The prediction of the combined hybrid or twin model 401 and 402 is compared with experimental data from a deployed link with deployed fiber channels 301 and deployed optical component 302 and the optical component model 402 is trained. The analytical part of the hybrid model ensures that the EDFA weights are only responsible for modelling EDFA effects. In a way, the NNs (neural networks) in the EDFA ML (machine learning) model are naturally regularized against overfitting to link-specific effects.

In one embodiment of the present disclosure, training of the optical component model may be done as follows: the EDFA model weights are initialized, and a cascade digital twin model of the fiber-EDFA-fiber link is created. Probe signals are sent on the link, and the system response is measured. The input probe signals consist of a shaped amplified spontaneous emission (ASE) spectrum with a random power profile. The spectrum is shaped so as to emulate a C-band, 48-channel, 12.5 GBd WDM signal on a 100 GHz grid. The response measurements consist of wavelength dependent power profile and ASE noise added at each channel of interest, measured using an optical spectrum analyzer (OSA). The mean squared error (MSE) between the model prediction and the measurements is estimated and used as cost for gradient descent-based EDFA weight updates. The analytical part of the EDFA hybrid model ensures that the EDFA weights are only responsible for modelling EDFA effects. In a way, the NNs in the EDFA ML model are naturally regularized against overfitting to link specific effects.

In one embodiment of the present disclosure, the parameters of the optical component model are determined by means of statistical modelling, linear regression, or other similar mathematical tools applied to predicted and experimental data, as known to the skilled person.

Input to the determination of the parameters of the optical component model, and/or for training of the optical component model, may be input spectral power profile to the probe link of input WDM signals, an operating point of the optical component, such as total input and total output power of the optical component, and an output spectral power profile of the probe link. Output for the determination of the parameters of the optical component model, and/or for training of the optical component model, may be the parameters of the optical component model.

Input to the determination of the power spectral profile output of the optical component may be the input power spectral profile of the optical component, which may be obtained from analytical models of the preceding optical fiber and/or hybrid analytical/machine learning models of preceding sections of the optical test link, and an operating point of the optical component, such as total input and total output power.

Output for the determination of the power spectral profile output of the optical component may be total power dependent gain profile and noise figure profile of the optical component.

In one embodiment of the present disclosure, the WDM input signals, used for determining the parameters of the optical component model and/or for training of the optical component model, may be shaped spectrum load signals with a random profile, such as shaped with amplified spontaneous emission spectrum with a random profile or sets of discrete optical carriers.

The measured WDM output signal, used for determining the parameters of the optical component model and/or for training of the optical component model, may be wavelength dependent output power profile and amplified spontaneous emission noise profile.

In the present disclosure, determining the parameters of the optical component model may be conducted on a computer system, for example on an embedded system or in a cloud system.

One embodiment of the present disclosure may further comprise providing a differentiable interpolation model for wavelength dependent implementation penalties of a transmitter-receiver (TRX).

In the present disclosure, the optical component model may comprise a gain profile of the optical component.

In the present disclosure the optical component model may comprise a calculated profile of amplified spontaneous emission (ASE).

Once the optical component model has been trained, using data from a link including, for example, only one optical component, the model so obtained may be used for modelling a fiber network with several optical components. If the optical components are of same make and manufacturer, the modelling of the fiber network with several optical components may be accurate.

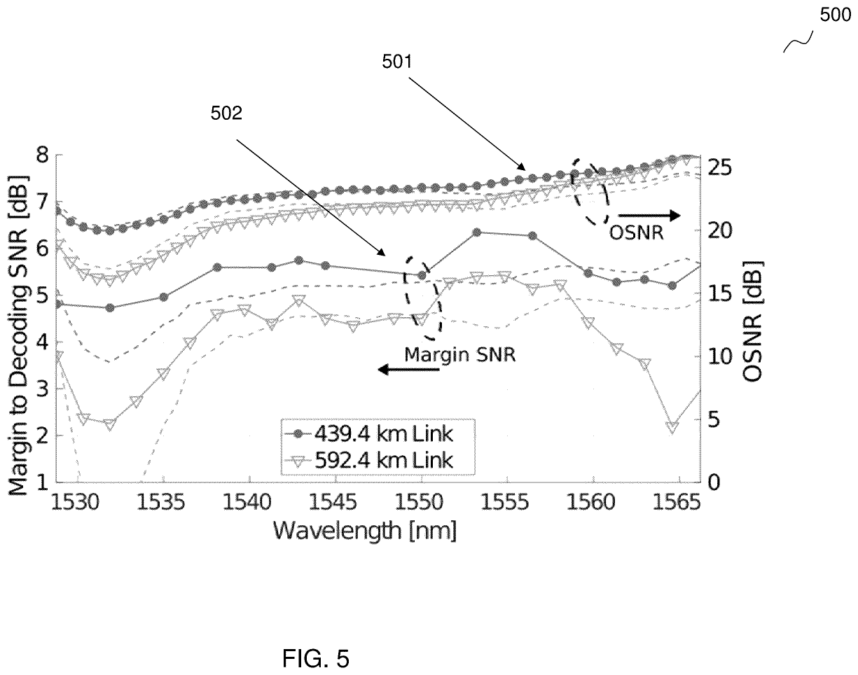

FIG. 5 shows a comparison 500 between experimental data in solid lines and modelling data in dashed lines, of two networks, of different lengths (439.4 km and 592.4 km respectively), comprising several EDFAs (4 and 6, respectively). The figure shows how the prediction is very close to measured data for both networks. Measured and predicted OSNR 501 are very close and measured and predicted SNR margin to SNR decoding threshold 502 are also very close.

Method for optimizing quality of service Once a model for the optical component, such as an EDFAs, has been obtained using the first presently disclosed characterization and/or modelling method, a remote link comprising one or more than one optical components may be modelled and optimized. In particular, a model of a remote link may comprise models of the optical components and models of the fiber channels and may predict output WDM signals from input WDM signals.

In one embodiment of the present disclosure, The EDFA ML (machine learning) model obtained using the presently disclosed characterization and modelling method is used in cascade with analytical fiber models and a TRX penalty model for performance prediction and gradient descent optimization of the input power profile to a chosen link of the network. The chosen cost function is Cost=−min_λ(SNR(λ)), targeting a flat SNR

In one embodiment of the present disclosure, the optical components of the remote link may be of same type and/or same manufacturer as the optical component of the probed link. If that is the case, the same model, obtained using the probed link, may be used for all optical components of the remote link. If EDFAs of different type or different manufacturer are used in the remote link, a probed link with one optical component for each of the different types or each of the different manufactures may be used to obtain tailored models for each of the optical components of the remote link.

The optical component model may be a parametric model.

The optical component model may be a machine learning model trained on probed input WDM signal and measured output WDM signals of the probed link.

In one embodiment of the presently disclosed method, optimizing the corresponding output optical signal to noise ratio is provided by maximizing the signal to noise ratio in a worst case scenario, or equalizing the signal to noise ratio for all users, or obtaining a custom distribution of the output signal to noise ratio per user, for example depending on subscriptions of each user.

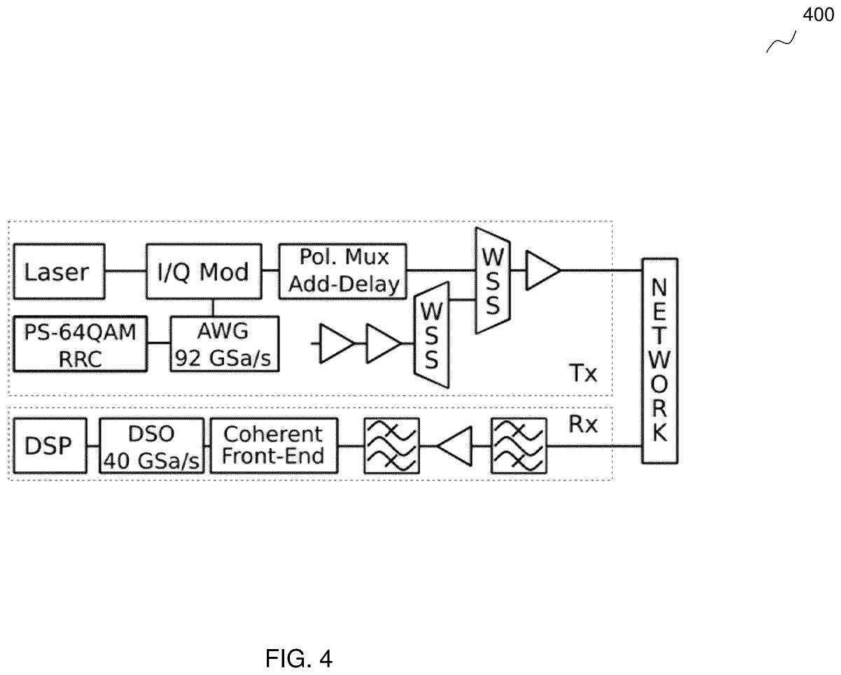

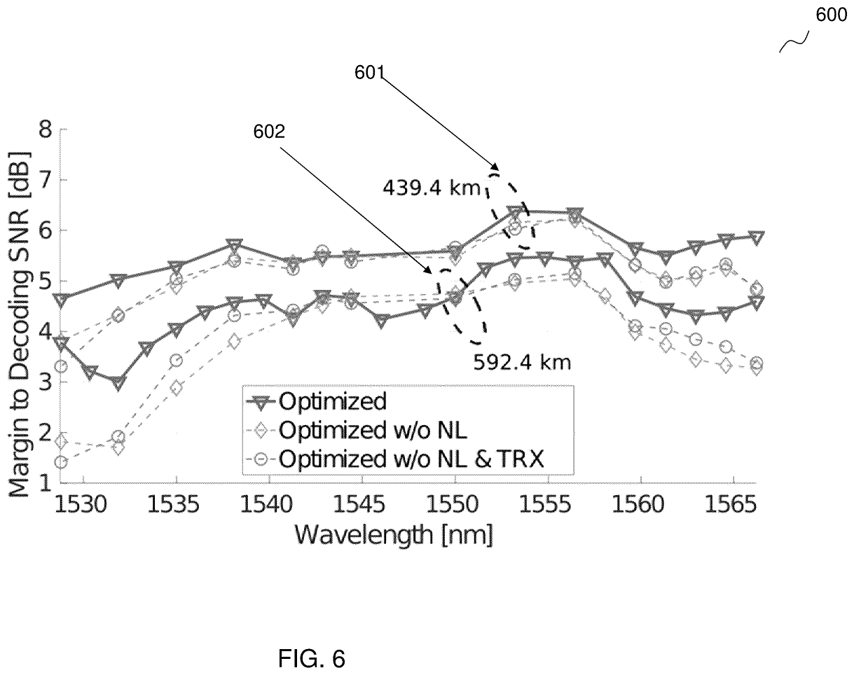

In the presently disclosed method, optimization may be done based on different criteria. Optimization is achieved by obtaining, for example, an optimum distribution of input power for all users and/or all wavelengths. In one embodiment, optimization may target a flat output SNR for all users. In the presently disclosed optimization method, equalizing the SNR for all users to a maximum SNR for all users for a given input power may be obtained by adjustment of the input spectral power per user, that is the input power profile, without requiring feedback on the quality of transmission and without requiring gain flattening filters for the EDFA. That is possible thanks to a link model comprising analytical models for the fiber channels and parametric and/or trained models for the EDFAs. The link model may also comprise differentiable interpolation model for wavelength dependent implementation penalties of the transmitter-receiver (TRX) chain. One embodiment of the TRX chain 400 is shown in FIG. 4. A result of one embodiment of the optimization 600 is shown, for example, in FIG. 6, where an almost flat distribution of the SNR is obtained for all wavelengths, for two different fiber links of length respectively 439.4 km 601 and 592.4 km 602. The flat SNR may be the highest possible achievable flat SNR over all wavelengths, given a total input power. FIG. 6 shows optimization in three different levels of complexity of the digital twin hybrid models: 1) model including all impairments with triangles; 2) model excluding stimulated Raman scattering and Kerr fiber nonlinearities (NL) with rhombus; 3) excluding NL and penalties of the transmitter TRX with circles.

In one embodiment of the present disclosure, distribution of input power may be optimized in order to achieve a higher output SNR for the wavelengths or the user that pay a higher subscription.

In one embodiment of the present disclosure, a worst case scenario is defined by at least a majority of users being active at the same time or by at least a majority of users requesting a high data rate at the same time, or by the remote link being overloaded or fully loaded or almost fully loaded.

In one embodiment of the present disclosure, the probed link is a laboratory WDM link or a pre-existing and and/or pre-deployed WDM link.

In one embodiment of the present disclosure, optimizing an obtained output signal to noise ratio for different wavelengths or for different users, is done by optimizing the input power profile of the link over the wavelengths, for a given total input power of the link.

In one embodiment of the present disclosure, the probed link may be a portion of the remote link. In particular, the probed link may be a portion of the remote link, comprising one optical component.

In one embodiment of the present disclosure, optimizing the quality of service is provided in real-time. As the remote link may be fully modelled by using trained optical component models and fiber channel analytical models, optimization of the input power profile over all the wavelengths may be obtained in real time, for example by using a cost function for the optimization.

The presently disclosed optimization method, may be based on a link model comprising parametric model(s) for the optical components obtained according to the presently disclose characterization and/or modelling method.

In one embodiment of the present disclosure, full modelling of field-deployed links without requiring access to all nodes nor feedback from the network on the current performance is achieved. modelling and optimization of operational systems, only requiring characterization of an isolated link is also achieved.

### Further Details

1. A method for obtaining a parametric model of a first optical component of a probed link in a WDM optical network comprising a plurality of link sections, the probed link comprising one or more of said link sections, each link section comprising a length of optical fiber and at least one of said first optical components, such as an optical amplifier, the probed link probed by a predefined WDM input signal and a measured WDM output signal, the method comprising the steps of:
   providing a link transfer model based on the predefined WDM input signal and the measured WDM output signal;
   isolating the first optical components from the link transfer model by using analytical models for the optical fiber and removing the impact of the optical fiber from the link transfer model to obtain an optical component model; and
   determining parameters of the optical component model, based on the predefined WDM input signal, by means of iterative comparison between calculated WDM output signal and the measured WDM output signal.
2. The method according to item 1, wherein the probed link comprises at least one second optical component different from the first optical component and wherein the first optical components is isolated from the link transfer model by also removing the impact of said at least one second optical component.
3. The method according to any one of the preceding items, wherein the optical component is an Erbium-Doped Fiber Amplifier (EDFA).
4. The method according to any one of the preceding items, wherein the optical component is a switch or a filter.
5. The method according to any one of the preceding items, wherein the parameters of the optical component model are determined by training the optical component model by means of machine learning based on the predefined WDM input signal and the measured WDM output signal.
6. The method according to any one of the preceding items, wherein the parameters of the optical component model are determined by means of statistical modelling and/or linear regression.
7. The method according to any one of the preceding items, wherein determination of the parameters of the optical component model is based on input power profile of input WDM signals, an operating point of the optical component, such as total input and total output power of the optical component, and an output spectral power profile of the probed link.
8. The method according to any one of the preceding items, wherein the WDM input signals, used for determining the parameters of the optical component model, are shaped spectrum load signals with a random profile, such as shaped with amplified spontaneous emission spectrum with a random profile or sets of discrete optical carriers.
9. The method according to any one of the preceding items, wherein the measured WDM output signal, used for determining the parameters of the optical component model, are wavelength dependent output power profile and amplified spontaneous emission noise.
10. The method according to any one of the preceding items, wherein the step of determining the parameters of the optical component model is conducted on a computer system, for example on an embedded system or in a cloud system.
11. The method according to any one of the preceding items, further comprising providing a differentiable interpolation model for wavelength dependent implementation penalties of a transmitter-receiver (TRX).
12. The method according to any one of the preceding items, wherein the optical component model comprises a gain profile of the optical component.
13. The method according to any one of the preceding items, wherein the optical component model comprises a calculated profile of amplified spontaneous emission (ASE).
14. A method for optimizing the quality of service of a remote link in a WDM optical network, the remote link comprising a plurality of link sections, each link section defined by a length of optical fiber and at least one optical component, such as an optical amplifier, the method comprising the steps of:
   modelling the WDM optical network link based on the link configuration to obtain a digital twin model of the WDM optical network link, wherein the digital twin model comprises an analytical model for the optical fibers and a parametric model for at least one of the optical components;
   calculating or predicting an output optical signal to noise ratio of an input WDM signal based on the digital twin model; and
   optimizing the quality of service of the WDM optical network link by determining an input WDM signal that optimizes the corresponding output optical signal to noise ratio,
   wherein parameters of the parametric model(s) for the at least one optical component are determined based on measurements on a probed link of the WDM optical network, and wherein the probed link is different from the remote link.
15. The method according to item 14, wherein the probed link comprises optical components of same type and/or the same manufacturer as the optical components in the remote link.
16. The method according to any one of items 14-15, wherein the parametric model is a machine learning model trained on probed input WDM signal and measured output WDM signals of the probed link.
17. The method according to any one of items 14-16, wherein optimizing the corresponding output optical signal to noise ratio is provided by maximizing the signal to noise ratio in a worst case scenario, or equalizing the signal to noise ratio for all users, or obtaining a custom distribution of the output signal to noise ratio per user, for example depending on subscriptions of each user.
18. The method according to item 17, wherein the worst case scenario is defined by at least a majority of users being active at the same time or by at least a majority of users requesting a high data rate at the same time, or by the remote link being overloaded or fully loaded or almost fully loaded.
19. The method according to any one items 14-18, wherein the probed link is a laboratory WDM link or a pre-existing and and/or pre-deployed WDM link.
20. The method according to any one items 14-19, further comprising optimizing an obtained output signal to noise ratio for different wavelengths or for different users, by optimizing the input power profile of the link over the wavelengths, for a given total input power of the link.
21. The method according to any one of items 14-20, wherein the probed link is a portion of the remote link.
22. The method according to any one of items 14-21, wherein optimizing the quality of service is provided in real-time.
23. The method according to any one of items 14-22, wherein the parametric model(s) for the at least one optical component is/are obtained according to the method of any of items 1-13.

1. A method for obtaining a parametric model of a first optical component of a set of optical components of a probed link in a WDM optical network comprising a plurality of link sections, the probed link comprising one or more of said link sections, each link section comprising a length of optical fiber and at least one of said set of optical components the probed link probed by a predefined WDM input signal and a measured WDM output signal, the method comprising:
providing a link transfer model based on the predefined WDM input signal and the measured WDM output signal;
isolating the first optical component from the link transfer model by using an analytical model for the optical fiber and removing the impact of the optical fiber from the link transfer model to obtain an optical component model; and
determining a set of parameters of the optical component model, based on the predefined WDM input signal, by iteratively comparing a calculated WDM output signal and the measured WDM output signal.

2. The method according to claim 1, wherein the probed link includes a second optical component of the set of optical components, the second optical component different from the first optical component, and wherein the first optical component is isolated from the link transfer model by also removing the impact of said second optical component.

3. The method according to claim 1, wherein the first optical component is an Erbium-Doped Fiber Amplifier (EDFA).

4. The method according to claim 1, wherein the first optical component is selected from the group consisting of an optical amplifier, a switch, a filter, and combinations thereof.

5. The method according to claim 1, wherein the set of parameters of the optical component model is determined by training the optical component model using machine learning based on the predefined WDM input signal and the measured WDM output signal.

6. The method according to claim 1, wherein the set of parameters of the optical component model is determined by using one or both of statistical modelling and linear regression.

7. The method according to claim 1, wherein the determination of the set of parameters of the optical component model is based on an input power profile of the WDM input signal, an operating point of the first optical component, and an output spectral power profile of the probed link.

8. The method according to claim 1, wherein the WDM input signal, used for determining the set of parameters of the optical component model, is a shaped spectrum load signal with a random profile.

9. The method according to claim 8, wherein the WDM input signal is shaped with an amplified spontaneous emission spectrum with a random profile or sets of discrete optical carriers.

10. The method according to claim 1, wherein the measured WDM output signal, used for determining the set of parameters of the optical component model, includes a wavelength dependent output power profile and amplified spontaneous emission noise.

11. The method according to claim 1, wherein determining the set of parameters of the optical component model is performed by a computer system.

12. The method according to claim 1, further comprising providing a differentiable interpolation model for wavelength dependent implementation penalties of a transmitter-receiver (TRX).

13. The method according to claim 1, wherein the optical component model includes a gain profile of the first optical component.

14. The method according to claim 1, wherein the optical component model includes a gain profile of the first optical component and a calculated profile of amplified spontaneous emission (ASE).

15. A method for optimizing a quality of service of a remote link in a WDM optical network, the remote link comprising a plurality of link sections, each link section comprising a length of optical fiber and at least one optical component, the method comprising:
modelling the remote WDM optical network link based on a link configuration to obtain a digital twin model of the WDM optical network link, wherein the digital twin model includes an analytical model for the optical fiber and a parametric model for at least one of the optical components;
calculating a predicted output optical signal to noise ratio of each one of a set of input WDM signals based on the digital twin model; and
optimizing the quality of service of the remote WDM optical network link by determining an optimal input WDM signal of the set of input WDM signals that optimizes the corresponding predicted output optical signal to noise ratio,
wherein one or more parameters of the parametric model for the at least one optical component are determined based on measurements on a probed link of the WDM optical network, and wherein the probed link is different from the remote link.

16. The method according to claim 15, wherein the probed link comprises optical components of one or both of a same type and a same manufacturer as the optical components in the remote link.

17. The method according to claim 15, wherein the parametric model is a machine learning model trained on a probed input WDM signal and measured output WDM signals of the probed link.

18. The method according to claim 15, wherein optimizing the corresponding predicted output optical signal to noise ratio includes a method selected from the group consisting of maximizing the signal to noise ratio in a worst case scenario, equalizing the signal to noise ratio for all users, obtaining a custom distribution of the output signal to noise ratio per user, for example depending on subscriptions of each user, and combinations thereof.

19. The method according to claim 15, wherein optimizing the quality of service is provided in real-time.

20. The method according to claim 15, wherein the parametric model for the at least one optical component is obtained according to the method of claim 1.
